(19) United States
(12) Patent Application Publication
(10) Pub. No.: US 2003/0213437 A1
(43) Pub. Date: Nov. 20, 2003

(54) Automatic water dispenser for pets

(76) Inventor: Joseph M. Norris, Greenville, NC (US)

Correspondence Address: Richard C. Litman, LITMAN LAW OFFICES, LTD., P.O. Box 15035, Arlington, VA, 22215, US

(21) Appl. No.: 10/426,865

(22) Filed: May 1, 2003

Related U.S. Application Data
(60) Provisional application No. 60/381,107, filed on May 20, 2002.

(51) Int. Cl. A01K 7/00

(52) U.S. Cl. 119/74

(57) ABSTRACT

The automatic water dispenser for pets includes a timer and a dispenser in which the timer has up to three user-selected settings. A panel holds the timer and a display showing the timer settings, the current time, and the temperature of the water in the dispenser. Also, push buttons are provided to permit the user to set the timer settings, to switch the timer between manual and automatic modes of operation, to set the clock, and to manually flush or fill the dispenser. Each of the three possible timer settings indicate the time during a daily period at which a flush and refill cycle occur to permit flushing and refilling of the dispenser.

### CROSS-REFERENCE TO RELATED APPLICATION

This application claims the benefit of U.S. Provisional Patent Application Serial No. 60/381,107, filed May 20, 2002.

### BACKGROUND OF THE INVENTION

1. Field of the Invention

The present invention relates to automatic water dispensers for pets. In particular, the invention includes a timer which is mounted inside a building structure (e.g., house) and a water dispenser located outside the building; the timer is set to automatically perform flush, fill or drain operations at up to three different times during a day. A display shows the time of day, the timer settings, and the temperature of the water in the dispenser.

2. Description of Related Art

Various pet watering devices and systems that include automatic operation, are known.

U.S. Pat. No. 4,630,569, issued to Dieleman on Dec. 23, 1986, teaches a birdbath including a control system with a timing means operated from within a structure to clean or fill the bath. The timer controls the length of the filling cycle rather than the time of day at which the filling or cleaning occur. U.S. Pat. No. 4,630,569 issued to Dieleman on Dec. 23, 1986, teaches a self-cleaning birdbath that includes a control system operated from inside a building.

U.S. Pat. No. 4,986,221 issued to Shaw on Jan. 22, 1991 teaches a livestock waterer including sensors for detecting the presence of an animal as well as an automatically operated drain valve. U.S. Pat. No. 5,433,171 issued to Ewell on Jul. 18, 1995, teaches an automatic pet food and water dispenser for use as a stand-alone unit. A timer is provided as well.

U.S. Pat. No. 5,582,132, issued to Morton on Dec. 10, 1996, teaches an automatic pet watering device that includes a lid through which the pet accesses the water supply. U.S. Pat. No. 5,813,363 issued to Snelling on Sep. 29, 1998, teaches another stand-alone automatic liquid dispenser for pets including a timer. However, there is no detailed disclosure of the operation or function of the timer.

U.S. Pat. No. 6,279,508 B1 issued to Marchant et al. on Aug. 28, 2001, teaches a pet watering system including a valve that automatically fills a bowl when the pet walks onto a spring-biased pedal. UK Patent No. 2,241,633 teaches a self-contained pet water dispenser.

The above references lack teachings or suggestions for an automatic water dispenser that includes up to three timer settings for daily flushing, draining and/or refilling an outside pet water dispenser.

None of the above inventions and patents, taken either singly or in combination, is seen to describe the instant invention as claimed.

### SUMMARY OF THE INVENTION

The present invention is an automatic water dispenser for pets including a timer and a dispenser. A display shows the timer settings (up to three are selected by the user), the current time, and temperature of the water in the dispenser. Push buttons permit the user to set the timer settings, switch the timer between manual and automatic modes of operation, set the clock, and manually flush or fill the dispenser. Each of the three possible timer settings indicate the time during a daily period at which a flush and refill cycle occur to permit flushing and refilling of the dispenser.

Accordingly, it is a principal object of the invention to provide an automatic water dispenser for pets including an indoor timer control and an outdoor dispenser.

It is another object of the invention to provide an automatic water dispenser in which the timer is mounted on an interior wall of a building structure and includes a display and push-button panel.

It is a further object of the invention to provide an automatic water dispenser having a timer in which up to three timing settings can be made for automatic draining, filling and flushing for up to three corresponding times daily.

It is a further object of the invention to provide a method of using an automatic water dispenser for pets.

It is an object of the invention to provide improved elements and arrangements thereof in an apparatus for the purposes described which is inexpensive, dependable and fully effective in accomplishing its intended purposes and in a method of its use.

These and other objects of the present invention will become readily apparent upon further review of the following specification and drawings.

### BRIEF DESCRIPTION OF THE DRAWINGS

FIG. 1 is an environmental, perspective view of an automatic water dispenser for pets according to the present invention.

FIG. 2 is a front view the timer display panel.

FIG. 3 is a diagrammatic view showing details of the dispenser.

Similar reference characters denote corresponding features consistently throughout the attached drawings.

### DETAILED DESCRIPTION OF THE PREFERRED EMBODIMENT

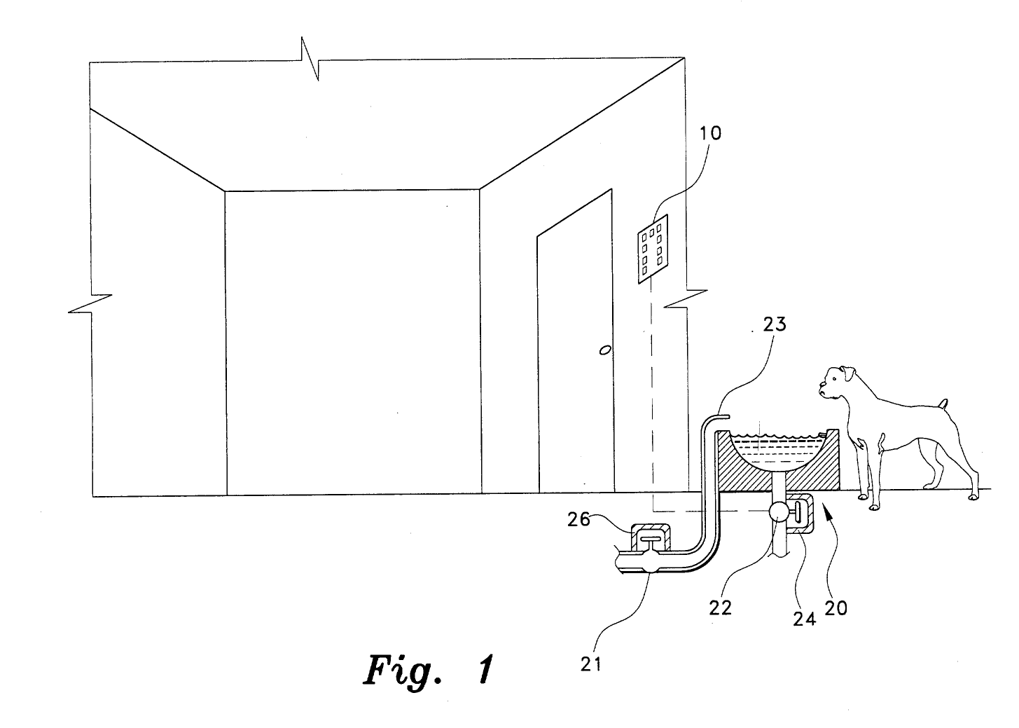

The present invention is directed to an automatic water dispenser for pets, as shown in FIG. 1, in which a timer panel 10 is mounted inside a building structure, such as a house.

The pet is shown with the dispenser 20 outside the building structure. Water enters the bowl portion of the dispenser through the inlet 23 and is controlled by inlet water control valve through the water source 21, e.g., using a solenoid-operated valve. The water source in the present invention is any common household tap, an outside hose bib, etc. The timer opens or closes the inlet water control valve to permit water to flow into the bowl or to flush the bowl in accordance with the settings of the user.

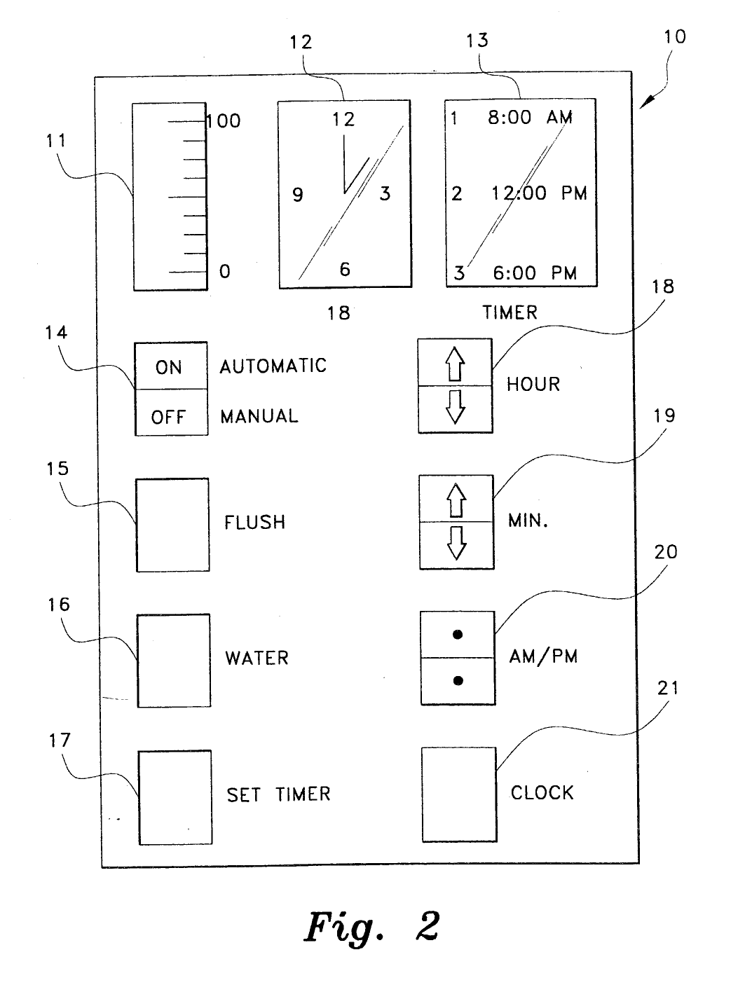

FIG. 2 shows details of the timer display panel 10. The temperature of the water in the bowl of the dispenser is measured by a thermocouple and transmitted to the indicator 11. The current time of day is shown at 12. The timer settings (up to three) are shown at the indicator 13.

During setting of the timer, the buttons 18, 19, 20 are used to adjust the hour, minute and AM/PM values, respectively. Switch 14 switches the timer between manual and automatic operation. Switches 15, 16, 17 and 21 set the mode of the timer between “Flush”, “Water”, “Set Timer” and “Clock” functions, respectively. During the flush operation, corresponding to the “Flush” function, the timer controls the drain valve to drain the dispenser and to control the water inlet valve to permit a slight excess of water to enter the bowl and to spill over in order to ensure that stale surface water or debris on the water surface is adequately removed. The “Water” operation permits the filling of the bowl with fresh water.

In order to set the (up to three) timer settings, the “Set Timer” switch is set, thereby permitting the user to enter the settings. The settings appear in the indicators 13.

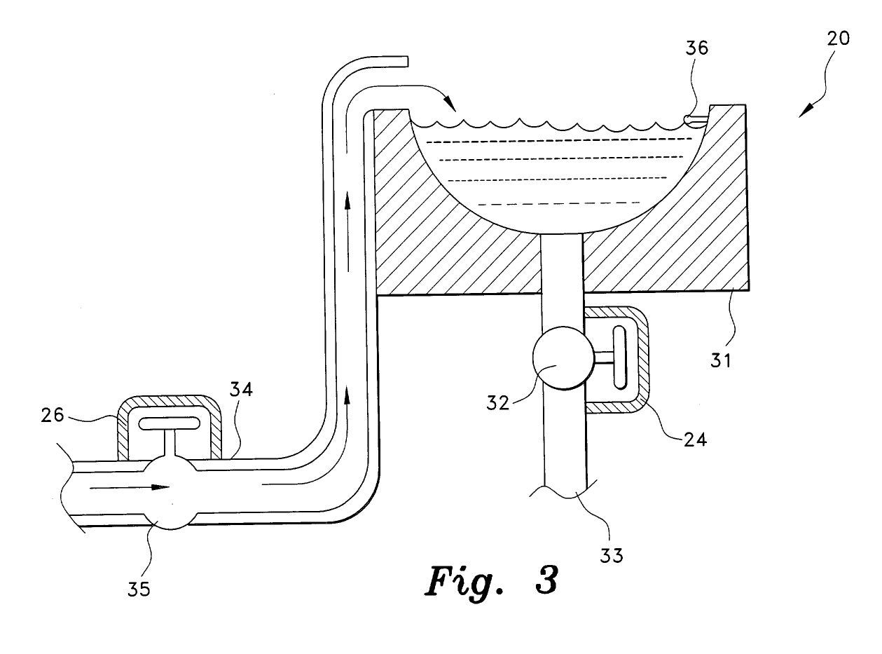

FIG. 3 shows the details of the dispenser 20 and dispenser housing 31. In particular, the inlet water valve 35 is connected to the water line 34 and permits the water to enter the bowl from the top. Drain valve 32 in the drain line 33 is used during the flush cycle to drain the bowl before refilling it with fresh water. Level detector 36 is used by the timer to stop the flow of water during the “Water” operation. Valve covers 24 and 26 are provided to protect the valve handles.

The method of operation of the automatic dispenser includes two possible scenarios: 1) changing the timer from manual to automatic operation; and 2) setting the timer to display the desired timer settings.

In manual mode, the user presses the “Set Timer” switch 17 and selects one of the three possible settings. The “Hour” 18, “Min” 19 and “AM/PM” 20 push buttons are pressed accordingly until the desired setting appears in the indicator 13. When settings are completed, the timer is placed into automatic mode using switch 14.

The clock switch 21 is used to permit adjustment or to lock the clock display 12.

Although FIG. 1 shows a single timer panel mounted on a wall, the invention contemplates any number of panels mounted at any corresponding number of locations in which any of the panels can be used to set the parameters and obtain the timing settings, the temperature of the water in the bowl and the time of day as described.

It is to be understood that the present invention is not limited to the sole embodiment described above, but encompasses any and all embodiments within the scope of the following claims.

I claim:

1. An automatic water dispenser for pets, comprising:
a dispenser having:
a bowl adapted for containing water;
a water inlet line discharging into the bowl;
a water inlet valve disposed in the water inlet line to control water inlet flow;
a drain line connected to the bowl for permitting the water to drain from the bowl;
a drain valve disposed in the drain line for controlling drain flow;
a temperature detector disposed in the bowl; and
a level detector disposed in the bowl;
a timer having a display panel, the display panel including:
a temperature indicator connected to the temperature detector;
a current time indicator;
a timer setting indicator displaying three timer settings;
a switch for setting the timer between an automatic and a manual mode;
a switch for setting the dispenser into a flush operation to drain and flush the dispenser; and
a switch for setting the dispenser into a fill operation to fill the dispenser; and
a water source connected to the water inlet line;
wherein the timer further includes means for automatically opening and closing the water inlet valve and the drain valve for flushing and filling the bowl with the water at programmable times.

2. The automatic water dispenser of claim 1, wherein the water source is a household tap.

3. The automatic water dispenser of claim 1, further including a static structure having at least one internal wall, the display panel being mounted on said at least one wall.

4. The automatic water dispenser of claim 3 wherein said at least one internal wall comprises a plurality of internal walls, the dispenser further comprising a plurality display panels, each of the display panels being mounted on a different one of the internal walls and displaying identical information and capable of setting the same timer settings.

5. The automatic water dispenser of claim 3, wherein the dispenser is placed outside of the static structure.
